(19) United States
(12) Patent Application Publication
(10) Pub. No.: US 2026/0352829 A1
(43) Pub. Date: Nov. 5, 2026

(54) THRESHOLD MODELS FOR SKIPPING ENTROPY CODING IN END-TO-END IMAGE COMPRESSION USING NEURAL NETWORKS

(71) Applicant: DOLBY LABORATORIES LICENSING CORPORATION

(72) Inventors: Arjun Arora, Sunnyvale, CA (US); Arunkumar Mohananchettiar, Bengaluru (IN); Peng Yin, Ithaca, NY (US); Jay Nitin Shingala, Bangalore (IN); Tong Shao, Sunnyvale, CA (US)

(73) Assignee: DOLBY LABORATORIES LICENSING CORPORATION, (US)

(21) Appl. No.: 19/489,139

(22) PCT Filed: May 31, 2024
(86) PCT No.: PCT/US2024/031854

§ 371 Date: Dec. 1, 2025

(30) Foreign Application Priority Data
Jun. 2, 2023 (IN) 202311038186
Sep. 13, 2023 (IN) 202311061566

(51) Int. Cl. H04N 19/13; H04N 19/124; H04N 19/42

(52) U.S. Cl. CPC H04N 19/13; H04N 19/124; H04N 19/42

(57) ABSTRACT

Methods are described for determining thresholds to skip entropy coding of latent features in image and video coding using a neural network. A threshold based on a mean of estimated standard deviations of all latents is proposed. For autoregressive neural networks, to avoid drift between context model parameter estimates computed during training and inference, it is proposed to have two separate entropy parameter estimation networks: an initial entropy-estimation network, to be used in entropy skip encoding and decoding of quantized latents, and a refined entropy-estimation network, to be used in arithmetic encoding and decoding of the quantized latents. Methods and systems for multi-stage entropy skipping are also proposed.

### CROSS-REFERENCE TO RELATED APPLICATIONS

This patent application claims priority to Indian Provisional Patent Application No. 202311038186, filed on Jun. 2, 2023 and Indian Provisional Patent Application No. 202311061566, filed Sep. 13, 2023, each of which is hereby incorporated by reference in its entirety

### TECHNOLOGY

The present document relates generally to images. More particularly, an embodiment of the present invention relates to thresholding models for skipping entropy coding in image and video compression using neural networks.

### BACKGROUND

In 2020, the MPEG group in the International Standardization Organization (ISO), jointly with the International Telecommunications Union (ITU), released the first version of the Versatile Video Coding standard (VVC), also known as H.266. More recently, the same group has been working on the development of the next generation coding standard that provides improved coding performance over existing video coding technologies. As part of this investigation, coding techniques based on artificial intelligence and deep learning are also examined. As used herein the term “deep learning” refers to neural networks having at least three layers, and preferably more than three layers.

As used herein the term “end-to-end image compression neural network” refers to a neural network that jointly optimizes all components of a video compression system, from the point of input of uncompressed input to the encoder, to the point of output of a reconstructed output image of the decoder, using a single loss function.

As appreciated by the inventors here, improved techniques for the coding of images and video based on neural networks are described herein.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Similarly, issues identified with respect to one or more approaches should not assume to have been recognized in any prior art on the basis of this section, unless otherwise indicated.

### BRIEF DESCRIPTION OF THE DRAWINGS

An embodiment of the present invention is illustrated by way of example, and not in way by limitation, in the figures of the accompanying drawings and in which like reference numerals refer to similar elements and in which:

FIG. 1 depicts an example neural-networks model for image and video coding based on the probabilistic modeling of latent features according to prior art; and

FIG. 2 depicts a first example neural network model for image and video coding for skipping entropy coding according to an embodiment of this invention;

FIG. 3 depicts a second example neural network model for image and video coding for skipping entropy coding according to an embodiment of this invention;

FIG. 4A depicts an example process for a two-stage entropy encoding according to an embodiment of this invention;

FIG. 4B depicts an example process for a two-stage entropy encoding with entropy skipping according to an embodiment of this invention;

FIG. 5A depicts an example of dividing the latent space using a quadtree partitioning according to an embodiment of this invention;

FIG. 5B depicts an example of a choice-mask to be used with entropy skipping according to an embodiment of this invention; and

FIG. 6 depicts an example process for multi-stage entropy skipping according to an embodiment of this invention.

### DESCRIPTION OF EXAMPLE EMBODIMENTS

Example embodiments that relate to skipping entropy coding (also to be referred as “entropy skipping’) in image and video coding using neural networks are described herein. In the following description, for the purposes of explanation, numerous specific details are set forth in order to provide a thorough understanding of the various embodiments of present invention. It will be apparent, however, that the various embodiments of the present invention may be practiced without these specific details. In other instances, well-known structures and devices are not described in exhaustive detail, in order to avoid unnecessarily occluding, obscuring, or obfuscating embodiments of the present invention.

### SUMMARY

Example embodiments described herein relate to image and video coding using neural networks. Methods are described for determining thresholds to skip entropy coding of latent features in image and video coding using a neural network. In a first embodiment, a threshold based on a mean of estimated standard deviations of all latents is proposed. In another embodiment, quantized latents with absolute value less than a threshold are replaced by a very small positive value and their entropy-encoding is skipped. For autoregressive neural networks, to avoid drift between estimates of context model parameter computed during training and inference, it is proposed to have two separate entropy parameter estimation networks: an initial entropy-estimation network, to be used in skipping entropy encoding and decoding of quantized latents, and a refined entropy-estimation network, to be used in arithmetic encoding and decoding of the quantized latents. Embodiments for multi-stage entropy skipping are also proposed.

### Example End-to-End Video Coding Model

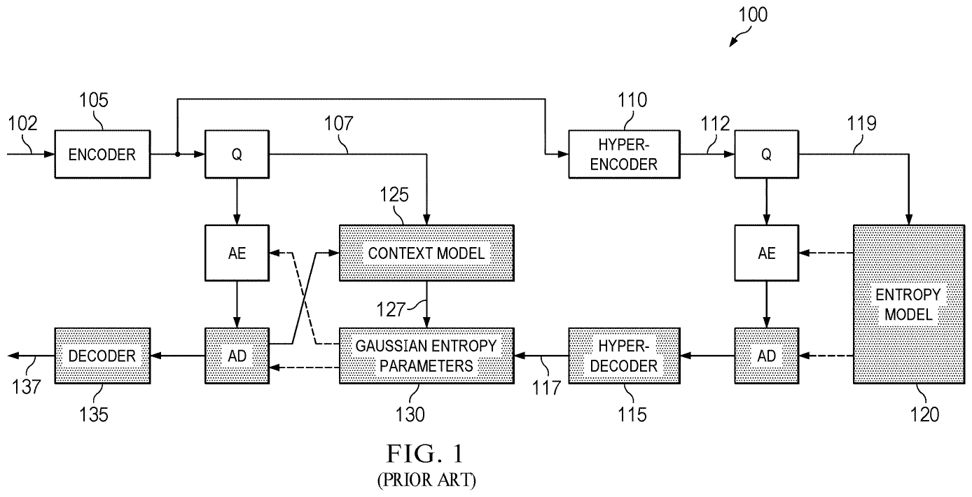

FIG. 1 depicts an example process (100) for modeling image and video coding based on neural learning and the coding of latent features (Refs. [1-2]). As used herein, the terms “latent features” or “latent variables” denote features or variables that are not directly observable but are rather inferred from other observable features or variables, e.g. by processing the directly observable variables. In image and video coding, the term ‘latent space’ may refer to a representation of the compressed data in which similar data points are closer together. In video coding, examples of latent features include the representation of the transform coefficients, the residuals, the motion representation, syntax elements, model information, and the like. In the context of neural networks, latent spaces are useful for learning data features and for finding simpler representations of the image data for analysis.

As depicted in FIG. 1, given input images 102, there are two main sub-networks: an autoencoder, which learns a quantized latent representation of the images (Encoder 105 and Decoder 135 blocks), and a sub-network which is responsible for learning a probabilistic model over quantized latents (ŷ) (107) used for entropy coding. The subnetwork combines the Context Model (125), an autoregressive model over latents, with the hyper-network (Hyper Encoder and Hyper Decoder blocks 110 and 115), which learns to represent information useful for correcting the context-based predictions. The data from these two sources is combined by an entropy modeling network (130), which generates parameters (e.g., the mean and variance) for a conditional Gaussian entropy model.

In FIG. 1, the arithmetic encoding (AE) blocks yield the compressed representation of the latent symbols (ŷ) (107) coming from the quantizer (Q), which is stored in a file. Therefore, at decoding time, any information that depends on the quantized latents may be used by the decoder once it has been decoded. In order for the context model 125 to work, it can only access previously decoded latents.

This model jointly optimizes an autoregressive component that predicts latents (y) from their causal context (Context Model 125) along with a hyperprior and the underlying autoencoder. Real-valued latent representations are quantized (Q) to create quantized integer-valued latents (ŷ) (107) and quantized hyperlatents (\hat{z}) (119), which are compressed into a bitstream using an arithmetic encoder (AE) and are decompressed by an arithmetic decoder (AD). Blocks with a cross-hatch background correspond to the components that are executed by the receiver to reconstruct an image (137) from a compressed bitstream.

As discussed in Ref. [1], a hierarchical prior (or hyperprior) z (112) is used to improve the entropy model of the latents by capturing their spatial dependencies. Such a model allows for end-to-end training, which includes joint optimization of a quantized representation of the hyperprior, the conditional entropy model, and the base autoencoder. Under this model, the compressed hyperpriors may be added to the generated bitstream as side information, which allows the decoder to use the conditional entropy model. In this way, a separate entropy model (120) of the hyperpriors allows for a richer and more accurate model.

The training goal is to minimize the expected length of the bitstream as well as the expected distortion of the reconstructed image with respect to the original, giving rise to a rate-distortion (R/D) optimization problem:

R+λD, (1)

where λ is the Lagrange multiplier that determines the desired rate-distortion (RD) trade-off, and R and D may be expressed as:

R=E_{x~p}_{ₓ}[−log₂ p_{ŷ}(q(ƒ(x)],

D=E_{x~p}_{ₓ}[d(x,g(q(ƒ(x)))], (2)

where pₓ denotes an unknown distribution of natural images, q(.) represents rounding to the nearest integer, y=ƒ(x) denotes an encoder output, ŷ=q(y) represents the quantized latents, p_{ŷ} is a discrete entropy model, and \hat{x}=g(ŷ) is the decoder output where \hat{x} represents the reconstructed image. The rate term corresponds to the cross entropy between the marginal distribution of the latents and the learned entropy model, which is minimized when the two distributions are identical. The distortion term may correspond to a closed-form likelihood, such as when d(x,\hat{x}) represents a measure of distortions, such as the Mean Squared Error (MSE), a Structural Similarity Image Measure (SSIM), Multiscale Structural Similarity (MS-SSIM), IW-SSIM (Information Content Weighted Structural Similarity Measure), FSIM (Feature Similarity Index Measure), PSNR-HVSM (Peak Signal to Noise Ratio Human Visual System Measure, taking into account a Contrast Sensitivity Function (CSF) and between-coefficient contrast masking of DCT basis functions), VMAF (Video Multi-method Assessment Fusion), VIF (Visual Information Fidelity measure), VDP2 (Visual Difference Predictor), NLPD (Normalized Laplacian Pyramid Distortion), and a learning-based distortion measure such as LPIPS (Learned Perceptual Image Patch Similarity), DISTIS (Deep Image Structure and Texture Similarity), and the like.

As in Ref. [1], because both the compressed latents and the compressed hyper-latents are part of the generated bitstream, the rate-distortion loss from equation (1) may be expanded to include the cost of transmitting 2. Coupled with the distortion metric D, the full loss function becomes:

R+λD+R_{z}, (3)

where

R_{z}=E_{x~p}_{ₓ}[−log₂ p_{\hat{z}}(\hat{z})] (4)

denotes the rate due to the hyper-latents.

This kind of end to end deep learning compression-based framework using neural networks in general consists of two parts: the core autoencoder and an entropy sub-network. The core autoencoder is used to learn a quantized latent vector of the input image or video signal. For this aspect, the key is to how to define an efficient neural-nets (NN) architecture. The entropy sub-network is responsible for learning a probabilistic model over the quantized latent representations, utilized for entropy coding. For this aspect, finding the right entropy model is very critical to reduce the bitrate overhead. Embodiments of the invention herein propose a new entropy modeling of latent features.

In Ref. [1], the latent features ŷ are modeled by a Gaussian distribution N(μ,σ²) with mean μ and standard deviation (or scale) σ. The mean and the standard deviation (which may also be referred to as a scale parameter) are estimated jointly using the auto-regressive context model parameters Φ (127) from previously reconstructed latents ŷ_{<i} and learned hyperprior features parameters Ψ (117) derived from the hyperprior latents \hat{z} coded in the bitstream as side information. The distribution of ŷᵢ latents is considered independently-conditioned on the hyperpriors and the context model.

### Entropy Skipping

As discussed in Ref. [3], in video coding, due to the use of reference frames, the entropy of the quantized latents is relatively small, thus having distribution functions with relatively small variance. It was proposed to skip entropy-encoding and entropy-decoding certain elements and simply replace them with the peak of their probability distribution. This can save both bit-rate and runtime in entropy encoding with little error expectations.

In Ref. [3], it was proposed to skip encoding those latents yᵢ which have high enough probability, qᵢ, that they are within ±0.5 of the center of their distribution. Using the erf( ) function

$$erf ( z ) = \frac{2}{\sqrt{π}} {\int }_{0}^{z} {e}^{- {t}^{2}} dt , \qquad ( 5 )$$

given the standard deviation σᵢ, one computes the probability

$${q}_{i} = erf ( \frac{1}{2 \sqrt{2} {σ}_{i}} ) . \qquad ( 6 )$$

Given this probability, one can apply a threshold τ to decide whether to encode or skip this element. That decision is described as

$${\hat{y}}_{i} = \{ \begin{matrix}{μ}_{i} , & if {q}_{i} \geq τ \\ [ {y}_{i} ] , & if {q}_{i} < τ\end{matrix} , \qquad ( 7 )$$

where μᵢ is the center (mean) of the Gaussian distribution, σᵢ is the standard deviation, τ∈[0, 1], for i=1, 2, . . . . N, N denoting the total number of latents. One can observe that qᵢ is a monotonic function of σᵢ so one can instead replace the error function calculation with a specially chosen threshold value for σᵢ, denoted here as τ_{σ}, which is associated with the value chosen for τ (e.g., τ=0.8), or

$${\hat{y}}_{i} \{ \begin{matrix}{μ}_{i} , & if {σ}_{i} < {τ}_{σ} \\ [ {y}_{i} ] , & if {σ}_{i} \geq {τ}_{σ}\end{matrix} , \qquad ( 8 )$$

where [ ] denotes the quantization operation.
Threshold Based on mean(σᵢ)

In an embodiment, it is proposed to improve upon the threshold proposed in Ref. [3] by taking into account all latent distributions. Rather than relying on an absolute threshold decided by the probability of yᵢ, instead, the proposed threshold relies on local thresholding and encourages the network to discard ~50% of the latents and skip their encoding. This is done by calculating the mean standard deviation term within the current set of latents and determining the skip threshold based on that value. Based on experiments, this results in ~60-70% of the latents being skipped. This entropy skipping model can be expressed as:

$${\hat{y}}_{i} \{ \begin{matrix}{μ}_{i} , & if {σ}_{i} < mean {( {σ}_{i} )}_{} \\ [ {y}_{i} ] , & if {σ}_{i} \geq mean ( {σ}_{i} )\end{matrix} , \qquad ( 9 )$$

where, for N latents

$$mean ( {σ}_{i} ) = \frac{1}{N} {\sum }_{1}^{N} {σ}_{i} .$$

For example, given input video patches of size W×H, and a CNN encoder network with M output channels, N=W/k×H/k×M, where k denotes a down-sampling ratio of the encoder, e.g., W=H=256, M=64 or 192, and k=16.

In an alternative embodiment, one determines which values to skip depending on the absolute magnitude of each yᵢ. In this method, if the absolute value of yᵢ is below some threshold τ, its value is not encoded into the bitstream and instead it is replaced with some non-zero epsilon (e.g., ε=1E⁻⁶). Since each latent is in a feature space, this method is analogous to DCT quantization, used commonly in the JPEG standard. Alternatively, since yᵢ values are not available in the decoder, the threshold may be defined in terms of the estimated mean, hence,

$${\hat{y}}_{i} = \{ \begin{matrix}\{ {y}_{i} ] , & if \vert {μ}_{i} \vert \geq τ \\ ε * sign ( {μ}_{i} ) , & if \vert {μ}_{i} \vert < τ\end{matrix} .$$

where sign(x)=1 if x is positive and −1 if x is negative, and threshold τ can be optimized via experimental results.

### Entropy Skipping in Auto-Regressive Models

In an auto-regressive network, as the one depicted in FIG. 1, the entropy (or context) model of the latents (125) is conditioned on the previously decoded latents in addition to the hyper-prior parameters (117). For example, in FIG. 1, this is depicted by a link from the AD block prior to decoder (135) to the context model (125). Since the conditioning in the entropy model uses more context, an autoregressive model is significantly more efficient in the compression of latents.

For such a neural network model, a direct application of the entropy-skipping scheme of equation (9) would require computing the entropy skipping threshold, e.g., mean(σᵢ), in an auto-regressive fashion, where the mean is computed over the previously decoded standard deviations. However, this approach does not work in practice. During training, for computational efficiency reasons, the auto-regressive computation of means (μᵢ) and scales (that is, standard deviations σᵢ) is to be done in parallel for all the latents using a masked convolution, the mask restricting the latents being used in the convolution to only those latents that were previously decoded. Since some of those latents would be skipped in the latent coding process, and the skip decision depends on the scales, this causes a chicken and egg situation in that the computation of the means and scales depends on the knowledge of the scales. If this is not taken care and all the latents are used in the computation of standard deviations (scales) and means without accounting for any latent skips, the model may show significant performance improvement during training, but the inference would show poor coding efficiency. This is due to some information leakage that happens in the training path of the network. The information leakage is due to not replacing the skipped latents with means in the computation of the output context parameters (127) in the context model (125). The training ends up using information not available during inference. During inference, the decoder does not have access to the skipped latents and hence it cannot reproduce the scales and means used during the encoding; furthermore, the skip decisions computed from the scales also cannot be retrieved. This causes a divergence between the encoder and the decoder.

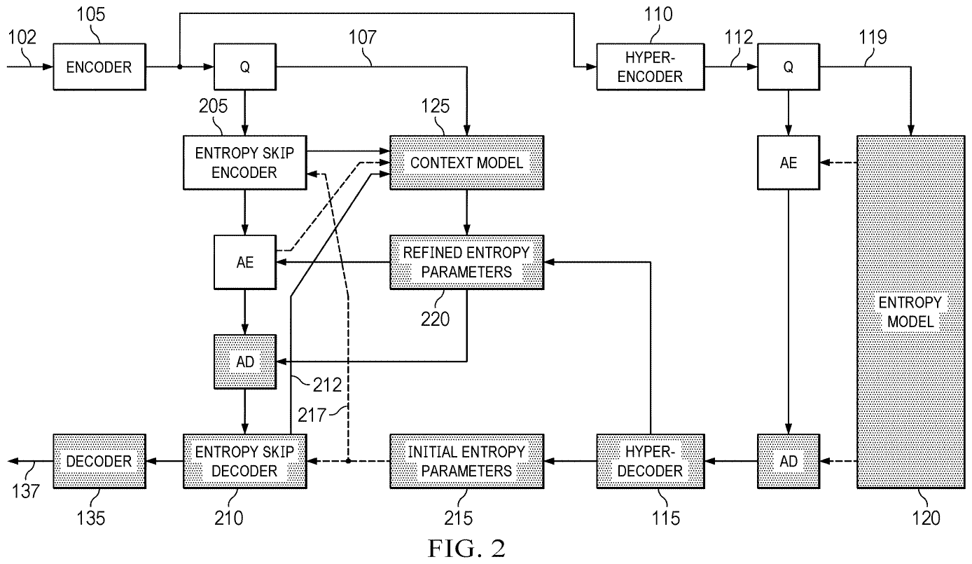

In an embodiment, this problem is addressed by modifying the original neural network to first produce an initial set of means and scales from the hyperprior information alone. FIG. 2 depicts the block diagram of the system. Compared to FIG. 1, the new network includes an entropy skip encoder (205) and an entropy skip decoder (210). It also replaces the original Gaussian entropy parameters estimation block (130) with two similar blocks: an initial entropy parameters estimation block (215) and a refined entropy parameters estimation block (220). The initial entropy parameters estimation block (215) estimates initial means and scales

$$( {μ}_{i}^{0} , {σ}_{i}^{0} )$$

to be used in entropy skipping. The output of the hyper-decoder (115) is also applied to a new refined-entropy parameters estimation block (220) to estimate refined means and scales

$$( {μ}_{i}^{r} , {σ}_{i}^{r} )$$

to be used in arithmetic encoding (AE) and arithmetic decoding (AD) of the quantized latents. In an embodiment, without limitation, the skip decisions are now made using the mean(σᵢ) method, wherein this scale-mean is obtained from the initial scales

$${σ}_{i}^{0}$$

(217), and the entropy-skipped latents are replaced with the initial means estimates

$${μ}_{i}^{0} .$$

The latent maps obtained from the entropy skip encoder (205) are used in context model block 125 for the computation of the context parameters, which are subsequently being used to compute in block 220 the refined means and scales. The refined means and scales are then used to get the probability distributions for coding the latents that are not skipped. At the decoder, the entropy skip decoder (210) provides latent maps (212) to the context modeler (125) to generate the context model during inference.

Experimental results confirmed the benefits of this approach. The training and inference paths give results that are in agreement, and the resulting codec is significantly more efficient than the codec without entropy skip. As discussed, the codec now has two entropy parameters networks, one that generates the initial means and scales and the other that generates refined means and scales. The network is trained by minimizing the rate-distortion loss from equation (3) where the rate R is the entropy of the autoencoder latents under the probability model using the refined mean and scale parameters. Since the initial means and scales are not directly affecting the rate-distortion loss, to ensure that the initial entropy parameters network is also properly trained, the rate R is modified to be a weighted average of the entropies of the autoencoder latents under the probability models using the refined and the initial mean and scale parameters. For example this weighting can be expressed as:

$$R = w * {E}_{x - {p}_{x}} [ - {log}_{2} {p}_{\hat{y}}^{0} ( q ( f ( x ) ) ) ] + ( 1 - w ) * {E}_{x - {p}_{x}} [ - {log}_{2} {p}_{\hat{y}}^{r} ( q ( f ( x ) ) ) , \qquad ( 11 )$$

where w denotes a weight in [0,1],

$${p}_{\hat{y}}^{0}$$

Is an initial discrete entropy model and

$${p}_{\hat{y}}^{r}$$

is a refined entropy model. It was found that the performance of the codec is not particularly sensitive to the value of w, and a value of w=0.5 was empirically found to work well.

During inference, the decoder first decodes the hyper latents and generates the initial means and scales using the initial entropy parameters network (215). The latent skip decisions are obtained from the initial scales. For example, using the model of equation (9), given initial means and scales

$$( {μ}_{i}^{0} , {σ}_{i}^{0} ) ,$$

every missing quantized latent in the stream of coded latents will be assigned a value of

$${\hat{y}}_{i} = {μ}_{i}^{0} .$$

The bitstream contains only the coded latents which are not skipped by the encoder. The entropy skip decoder (210) takes in the arithmetic decoded latents from the bitstream and fills in the skipped latents with the corresponding initial means estimates to produce the output latents so far decoded, which is used by the context model (125) as the context input. The refined entropy parameter network (220) generates the refined means and scales using the output of the context model (125) along with the hyper prior parameters. Refined means and scales are then used to produce the entropy model used by the arithmetic decoder (AD) to decode subsequent latents from the bitstream in an autoregressive fashion.

### Entropy Skipping in Multi-Stage Entropy Models

Current state of the art neural network-based compression models (Refs. [4-5]) have opted to relax the autoregressive entropy coding approach due to run-time constraints. The autoregressive model, while offering the best performance, is not parallelizable. A popular alternative approach for entropy models is a multi-stage entropy model. These multi-stage models are like auto-regressive entropy models but with a slight difference. Instead of encoding each latent element in a sequential manner conditioned on the previous latent element, multi-stage models partition the latent into multiple blocks and are encoded in parallel.

This partitioning strategy is commonly known as two stage checkerboarding or four stage quadtree partitioning, although alternative partitioning trees with eight or more partitions can also be employed. The checkboard partitioning is simply dividing the latent tensor into odd and even spatial elements and then splitting the channels in half. This results in a partition with odd elements, with one half of the channels, and another partition with the remaining half of the channels with the even elements. The selected latents are then encoded with the predicted μ_{i,0}, σ_{i,0}. Using the first stage entropy parameters μ_{i,0}, σ_{i,0} and the processed latent ŷᵢ are then used to compute the second stage entropy parameters μ_{i,1}, σ_{i,1} for the remaining latents that have yet to be encoded. The quadtree partitioning is similar to the checkerboard partition strategy but divides the channels into four partitions and partitions the latent spatially into a quadtree structure. More details can be found in Refs. [4,5] and will be discussed later in this section.

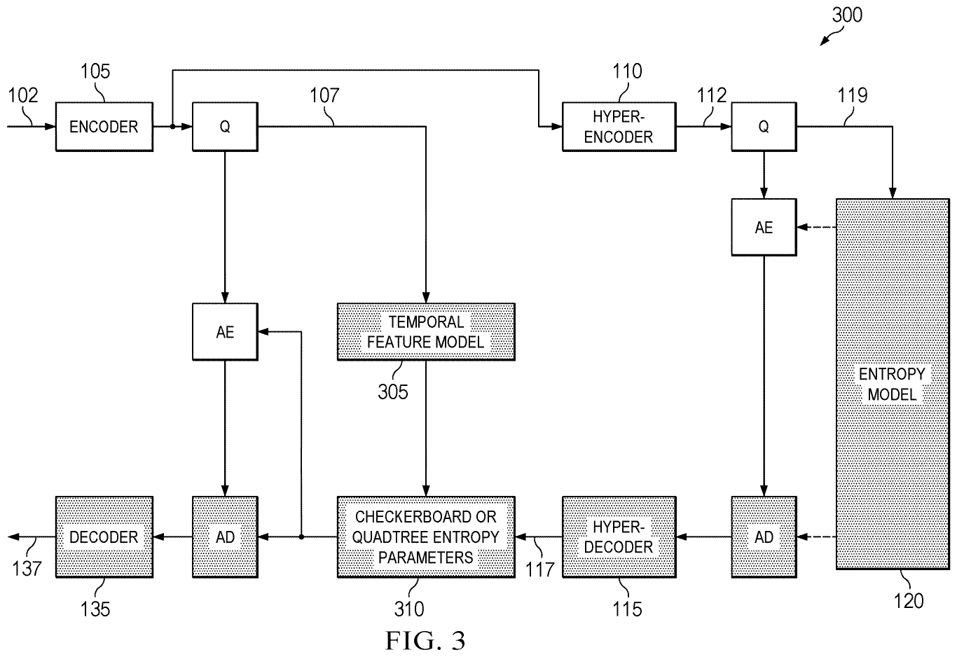

FIG. 3 depicts an example block diagram of such system (300). Compared to FIG. 1, the output 107 of the quantizer (Q) is now fed to an optional temporal feature model block (305) and then to a checkerboard or quadtree entropy parameters block (310), replacing the context model (125) and Gaussian entropy parameters (130) blocks, but also removing the need for a feedback from the decoder AD back to the context model (125).

The role of the temporal feature model block is to add temporal information (or modeling parameters), such as motion vector information, when encoding video sequences. Thus, while for still images or the first frame in a video sequence this block is not used, its use in subsequent frames in a video sequence adds additional modeling information which can improve the estimation of the entropy parameters.

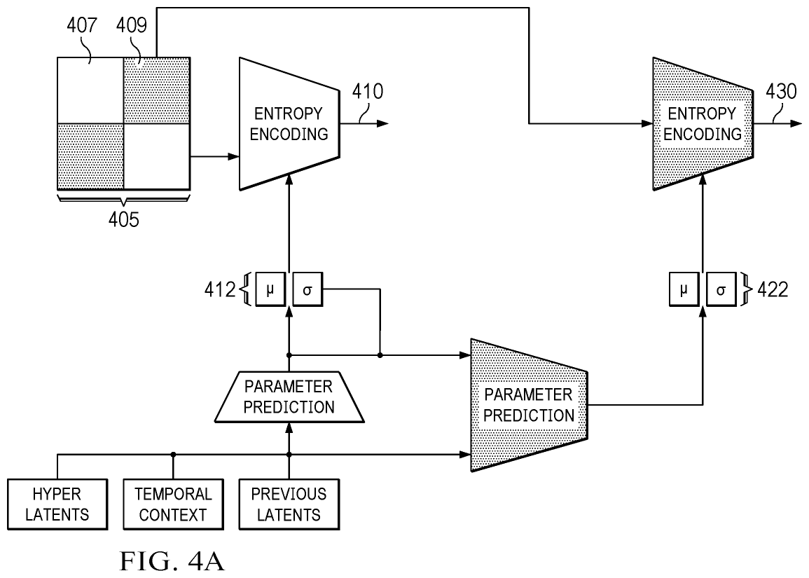

In traditional, “single frame” entropy encoding, given a sequence of quantized latents (subsequently, for simplification, to be referred to as just latents) (405), one computes the entropy parameters μ and σ for the whole “frame,” to generate a coded bitstream. FIG. 4A depicts an example of checker-board partitioning which allows for parallelizing the entropy encoding process across “white” (407) and “black” (409) areas of the latents of frame (405). The depiction of only four latents in frame 405 is simply an example and not limiting. As depicted in FIG. 4A, a first stage bitstream (410) can be generated based only on the white latents (407) and their corresponding μ and σ stage 1 entropy parameters (412). A second stage bitstream (430) can be generated based only on the black latents (409); however, the second stage-entropy parameters (422) are conditioned based on the first-stage entropy parameters (412), the hyper latents, temporal context (if available), and previous latents (black or white).

FIG. 4B depicts an example of a two-stage entropy coding model using entropy skipping. As depicted, for stage one, given the entropy parameters (μ, σ) (412) and the corresponding thresholds (e.g., see equation (9)) one computes a Boolean choice-mask (435) in the black and white latents determining which of the white latents can be entropy skipped.

In general, each latent has an associated mean and scale parameter. In an embodiment, for each set of stage latents (e.g. in FIG. 4B, stage 1: latents A and D, stage 2: latents B and C) one takes the average scale (variance) of all latents, either in that stage or across all latents. Next, if a latent scale in the stage is above the average scale, then one encodes the latent otherwise it is entropy-skipped. Typically, one never entropy-skips all latents in a stage, but one is often skipping a large majority of the elements in each stage. As an example, in FIG. 4B, based on choice mask 435, for stage 1, one entropy-skips latent D and entropy encodes latent A. For stage 2, based on choice mask 440, one only encodes latent C and entropy skips latent B.

Choice masks identify to the encoder and the decoder what values are kept and what values are skipped and need to be recomputed. In general, in each stage, a choice mask value for a specific latent is set to zero when its scale value is less than the computed average of all variances of the elements in that stage, otherwise it is set to 1, signifying that it is not entropy-skipped. Note that choice masks don't need to be sent from an encoder to the decoder. A decoder has all information needed to compute the mean and scale entropy parameters, and corresponding masks, based on the hyper-latents and optional temporal context and past decoded latents. A decoder will simply replace skipped latents with the estimated mean of each stage.

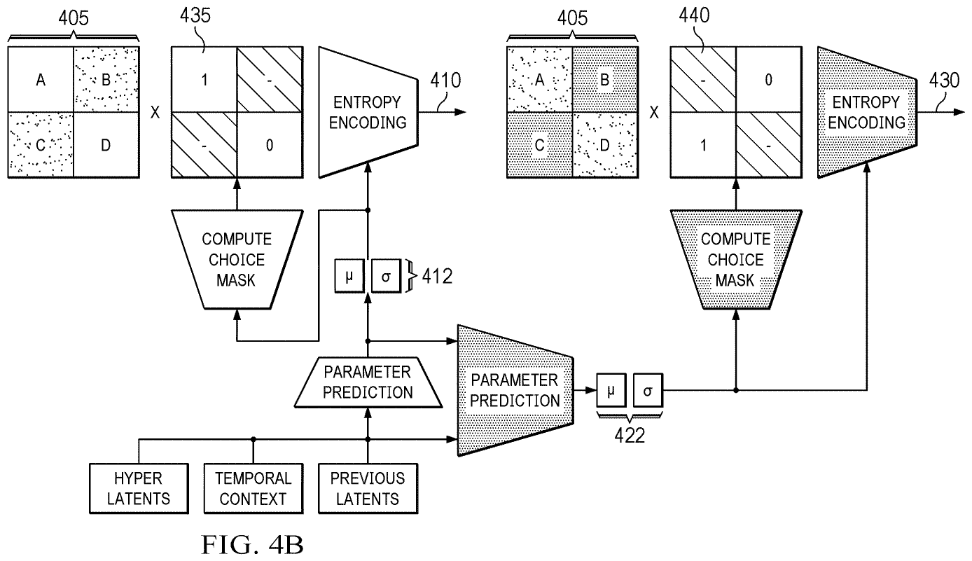

Expanding the methodology to a quadtree partitioning, FIG. 5A depicts a division of the latent space (505) into a quadtree representation with quantized latent areas (or stages) 1, 2, 3, and 4. In such a scenario, one would start by entropy encoding the “1” latents, use the updated context information to entropy encode the “2” latents, use the updated context information to encode the “3” latents, and finally encode the “4” latents. Again, the depiction of only 16 latents (505) is an example and is not limiting. Once all four latent areas are encoded, one can transmit the four bitstreams. When using entropy skipping, the Boolean choice masks (e.g., 435, 440) need to be adapted to support the new quadtree structure. An example of such a choice mask is depicted in FIG. 5B, where, without limitation, one selects to entropy encode two latents in the “1” stage and skip the other two, or in a (row, column) representation: encode latents (1,1) and (3,3) and skip encoding latents (1,3) and (3,1). For example, after encoding the “1” stage, one continues with the stage “2” latents, e.g., encoding latents (1,2), (3,2), and (3,4) (skipping latent (1,4)), the stage “3” latents, e.g., encoding latent (2,1) (and skipping latents (2,3), (4,1), and (4,3), and encoding all stage “4” latents, e.g., latents (2,2), (2,4), (4,2) and (4,4) (with no entropy skips).

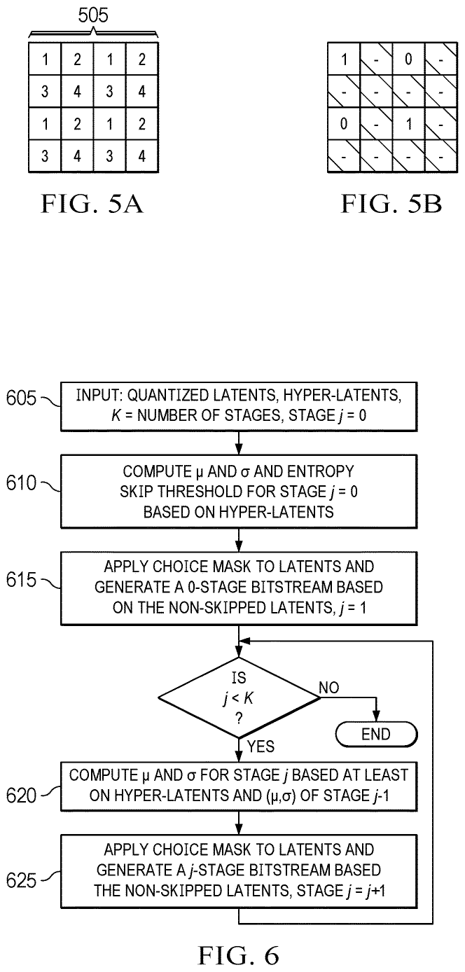

In summary, in this type of neural network model, the application of the entropy-skipping scheme of equation (9) requires computing the entropy skipping threshold, e.g., mean(σᵢ), for each stage in the partitioning strategy. This is due to the gradual refinement of the entropy parameters which are refined at each stage and are conditioned on the previous stage. With these new scale parameters, a new entropy-skipping threshold needs to be computed otherwise there will be a mismatch between the actual entropy parameters and the initial entropy parameters in which the choice mask was computed for. This process is summarized in FIG. 6.

However, the processing of the latents is the same as previously described models, that is, for elements which are skipped, ŷᵢ=μ_{i,m}.

As depicted in FIG. 6, given a multi-stage entropy skipping model, the entropy skipping process starts in step 605 with input the quantized latents and hyper-latents and optional temporal-context (if applicable). As an example, the first stage is denoted as stage j=0 (out of K total stages). For example, for a checkerboard division K=2, and for a quadtree division K=4.

For stage j=0, in step 610, one computes the corresponding entropy parameters (μ_{i,0},σ_{i,0}) and the entropy-skipping threshold. Then, in step 615, based on the computed thresholds, one generates a choice mask to select which latents are to be entropy skipped and to generate a coded bitstream for this stage based on the non-skipped latents.

Subsequently, after the first stage, one detects whether the whole latent space (all K stages) has been encoded. If not, stage-specific bitstreams are generated as follows:
compute corresponding entropy parameters (μ_{i,j},σ_{i,j}) based on the hyper-latents and (μ_{i, j-1},σ_{i, j1), and optionally based on past latents and temporal context (if available) (step 620); then in step (625)}
   computed updated entropy skipping threshold for stage j
   compute chaise-masks to define latents that can be entropy skipped
   generate an entropy-coded bitstream for stage j using the non-skipped latents
      Steps 620 and 625 are repeated until all K stages are coded.

In a decoder, the process is identical, except that the computed choice masks will be used to regenerate skipped quantized latent elements by simply assigning to them the mean latent value for each stage. Then, the received decoded bitstream and the reconstructed missing elements will be combined to form the final, decoded, bitstream.

Experimental results have shown that training with multi-stage entropy-skipping results in an increase in the efficiency of the codec. The network is trained by minimizing the rate-distortion loss from equation (3) with a slight difference. Prior to computing the rate term defined in equation (2) the elements which are skipped need to be masked out in order to avoid overestimating the rate. This mask M is formed from the choice mask at each stage merged into a single mask by simply adding them together. The rate term is then computed as the following.

R=E_{x~p}_{ₓ}[M*−log₂ p_{ŷ}(*q(ƒ(x)))] (12)

### REFERENCES

Each one of the references listed herein is incorporated by reference in its entirety.
[1] D. Minnen, J. Balle', and G. Toderici. “Joint autoregressive and hierarchical priors for learned image compression.” 32nd Conf. on Neural Information Processing Systems (NeurIPS 2018), Montreal, Canada, 2018.
[2] D. Liu, Y. Li, J. Lin, H. Li, F. Wu, “Deep learning-based video coding: A review and a case study.” arXiv: 1904.12462v1, Apr. 29, 2019.
[3] Y. Shi, Y. Ge, J. Wang, J. Mao,” AlphaVC: High-Performance and Efficient Learned Video Compression,” arXiv: 2207.14678, Jul. 29, 2022.
[4] Li, Jiahao, Bin Li, and Yan Lu. “Hybrid spatial-temporal entropy modelling for neural video compression.” Proceedings of the 30th ACM International Conference on Multimedia. 2022.
[5] Li, Jiahao, Bin Li, and Yan Lu. “Neural video compression with diverse contexts.” Proceedings of the IEEE/CVF Conference on Computer Vision and Pattern Recognition. 2023.

### Example Computer System Implementation

Embodiments of the present invention may be implemented with a computer system, systems configured in electronic circuitry and components, an integrated circuit (IC) device such as a microcontroller, a field programmable gate array (FPGA), or another configurable or programmable logic device (PLD), a discrete time or digital signal processor (DSP), an application specific IC (ASIC), and/or apparatus that includes one or more of such systems, devices or components. The computer and/or IC may perform, control, or execute instructions relating to skipping entropy coding of latent features in image and video coding, such as those described herein. The computer and/or IC may compute any of a variety of parameters or values that relate to skipping entropy coding of latent features in image and video coding described herein. The image and video embodiments may be implemented in hardware, software, firmware and various combinations thereof.

Certain implementations of the invention comprise computer processors which execute software instructions which cause the processors to perform a method of the invention. For example, one or more processors in a display, an encoder, a set top box, a transcoder, or the like may implement methods related to skipping entropy coding of latent features in image and video coding as described above by executing software instructions in a program memory accessible to the processors. Embodiments of the invention may also be provided in the form of a program product. The program product may comprise any non-transitory and tangible medium which carries a set of computer-readable signals comprising instructions which, when executed by a data processor, cause the data processor to execute a method of the invention. Program products according to the invention may be in any of a wide variety of non-transitory and tangible forms. The program product may comprise, for example, physical media such as magnetic data storage media including floppy diskettes, hard disk drives, optical data storage media including CD ROMs, DVDs, electronic data storage media including ROMs, flash RAM, or the like. The computer-readable signals on the program product may optionally be compressed or encrypted. Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (e.g., that is functionally equivalent), including components which are not structurally equivalent to the disclosed structure which performs the function in the illustrated example embodiments of the invention.

### EQUIVALENTS, EXTENSIONS, ALTERNATIVES AND MISCELLANEOUS

Example embodiments that relate to skipping entropy coding of latent features in image and video coding are thus described. In the foregoing specification, embodiments of the present invention have been described with reference to numerous specific details that may vary from implementation to implementation. Thus, the sole and exclusive indicator of what is the invention, and what is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

Various aspects of the present disclosure may be appreciated from the following Enumerated Example Embodiments (EEEs):
EEE1. In a neural network for video coding, a method for skipping entropy encoding of quantized latents, the method comprising:
   inputting video content into a neural-network encoder to generate latents (yᵢ); quantizing the latents to generate quantized latents (ŷᵢ);
   estimating mean values (μᵢ) and standard deviations (σᵢ) of the latents; and
applying entropy encoding to the quantized latents, wherein for a quantized latent (ŷᵢ)
if

$${σ}_{i} < {mean}_{} ( {σ}_{i} ) , then {\hat{y}}_{i} = {μ}_{i} ,$$

and its entropy encoding is skipped,
   else the quantized latent (ŷᵢ) is entropy encoded to generate an entropy encoded latent, wherein

$${mean}_{} ( {σ}_{i} )$$

denotes the average of all σᵢ values, for i=1, 2, . . . N, where N denotes the total number of generated latents.
EEE2. In a neural network for video coding, a method for skipping entropy encoding of quantized latents, the method comprising:
   inputting video content into a neural-network encoder to generate latents (yᵢ);
   quantizing the latents to generate quantized latents (ŷᵢ);
   estimating mean values (μᵢ) of the latents; and
   applying entropy encoding to the quantized latents, wherein for a latent yᵢ,
if ∥μᵢμ<τ, then ŷᵢ=ε*sign(μᵢ) and its entropy encoding is skipped, else the quantized latent (ŷᵢ) is entropy encoded to generate an entropy encoded latent, wherein τ denotes a threshold, and ε denotes a small positive value larger than zero and smaller than 0.001.
EEE3. In an autoregressive neural network for video coding, a method for skipping entropy encoding of quantized latents, the method comprising:
   inputting video content into a neural-network encoder to generate latents (y;);
   quantizing the latents to generate quantized latents (ŷᵢ);
   estimating initial mean values

$$( {μ}_{i}^{0} )$$

and standard deviations

$$( {σ}_{i}^{0} )$$

of the latents;
applying the initial mean values

$$( {μ}_{i}^{0} )$$

and initial standard deviations

$$( {σ}_{i}^{0} )$$

of the latents to an entropy-skip encoder to determine updated quantized latent values and whether a quantized latent value will be entropy encoded or entropy encoding for the quantized latent will be skipped;
based at least on the entropy-skipped and non-entropy skipped latents, estimating refined mean values

$$( {μ}_{i}^{r} )$$

and standard deviations

$$( {σ}_{i}^{r} )$$

of the talents; and
applying the refined mean values

$$( {μ}_{i}^{r} )$$

and standard deviations

$$( {σ}_{i}^{r} )$$

of the latents for the arithmetic encoding and arithmetic decoding of the latents to be entropy coded.
EEE4. The method of EEE3, wherein determining updated quantized latent values and whether a quantized latent value will be entropy encoded or entropy encoding will be skipped, comprises:
   if

$${σ}_{i}^{0} < {mean}_{} ( {σ}_{i}^{0} ) , then {\hat{y}}_{i} = {μ}_{i}^{0} ,$$

and its entropy encoding is skipped,
   else ŷᵢ is entropy encoded to generate an entropy encoded latent,
   wherein

$${mean}_{} ( {σ}_{i}^{0} )$$

denotes the average of all

$${σ}_{i}^{0}$$

values, for i=1, 2, . . . N,
where N denotes the total number of generated latents.
EEE5. The method of EEE3, wherein determining updated quantized latent values and whether a quantized latent value will be entropy encoded or entropy encoding will be skipped, comprises:
   for a latent yᵢ,
   if

$$\vert {μ}_{i}^{0} \vert < τ , then {\hat{y}}_{i} = ε * sign ( {μ}_{i}^{0} )$$

and its entropy encoding is skipped,
   else the quantized latent (ŷᵢ) is entropy encoded to generate an entropy encoded latent, wherein τ denotes a threshold, and ε denotes a small positive value larger than zero and smaller than 0.001.
EEE6. A method for decoding pictures using a neural network, the method comprising:
   receiving a bitstream comprising coded latents and coded hyper-latents;
   decoding the hyper-latents to generate hyperprior parameters and initial entropy parameters comprising initial mean values and initial scales;
   applying the initial scales into an entropy-skip decoder to identify skipped output latents, wherein the skipped output latents comprise latents that were not entropy-coded by an encoder of the bitstream;
   determining values of the skipped output latents based on the initial mean values;
   applying the skipped output latents and the hyperprior parameters to a context model to generate refined entropy parameters comprising refined mean values and refined scales;
   applying the refined entropy parameters to decode the coded latents and generate non-skipped output latents;
   and generating an output decoded picture based at least on the values of the skipped output latents and the non-skipped output latents.
EEE7. In a neural network for video coding, a method for skipping entropy encoding of quantized latents, the method comprising:
   inputting video content into a neural-network encoder to generate latents (yᵢ);
   quantizing the latents to generate quantized latents (ŷᵢ);
   dividing the quantized latents into K non-overlapping groups of quantized latents;
   estimating mean values

$$( {μ}_{i}^{0} )$$

and standard deviations

$$( {σ}_{i}^{0} )$$

of the quantized latents in group j=0 of the K groups based on hyper-latents;
applying the mean values

$$( {μ}_{i}^{0} )$$

and standard deviations

$$( {σ}_{i}^{0} )$$

of the latents to an entropy-skip encoder to determine output latent values for the group j=0;
for quantized latents in group j for groups j=1 to K−1 of the K groups:
   estimating mean values

$$( {μ}_{i}^{j} )$$

and standard deviations

$$( {σ}_{i}^{j} )$$

of the quantized latents in the group j based on hyper-latents and the

$$( {μ}_{i}^{j - 1} , {σ}_{i}^{j - 1} )$$

values;
applying the mean values

$$( {μ}_{i}^{j} )$$

and standard deviations

$$( {σ}_{i}^{j} )$$

of the latents to the entropy-skip encoder to determine output coded latent values for the group j; and
generating a bitstream of encoded quantized latents based on the output coded latent values for the K groups.
EEE8. The method of EEE7, wherein K=2 or 4.
EEE9. The method of EEE7 or EEE8, wherein determining output latent values and whether a quantized latent value will be entropy encoded or entropy encoding will be skipped, comprises:
   if

$$+ {σ}_{i}^{j} < {mean}_{□} ( {σ}_{i}^{j} ) , then - {\hat{y}}_{i} = {μ}_{i}^{k} ,$$

and its entropy encoding is skipped,
   else ŷᵢ is entropy encoded to generate an entropy encoded output latent,
   wherein

$${mean}_{□} ( {σ}_{i}^{j} )$$

denotes the average of all

$${σ}_{i}^{j}$$

values for quantized latents in group j.
EEE10. A method for decoding pictures using a neural network, the method comprising:
   receiving a bitstream comprising coded latents and coded hyper-latents, wherein the coded latents represent quantized latents divided into K non-overlapping groups;
   for group j=0 of the coded latents:
      decoding the hyper-latents to generate hyperprior parameters and initial entropy parameters comprising initial mean values

$$( {μ}_{i}^{0} )$$

and initial scales

$$( {σ}_{i}^{0} ) ;$$

applying the initial scales into an entropy-skip decoder to identify skipped output latents, wherein the skipped output latents comprise latents that were not entropy-coded by an encoder of the bitstream; and
determining values of the skipped output latents for group j=0 based on the initial mean values;
for group j, j=1 to K−1, of the coded latents:
   estimating mean values

$$( {μ}_{i}^{j} )$$

and standard deviations

$$( {σ}_{i}^{j} )$$

of the quantized latents in the group j based on the hyper-latents and the

$$( {μ}_{i}^{j - 1} , {σ}_{i}^{j - 1} )$$

values; and
applying the estimated mean values

$$( {μ}_{i}^{j} )$$

and the standard deviations

$$( {σ}_{i}^{j} )$$

to decode the coded latents and generate skipped and non-skipped output latents.
and generating an output decoded picture based at least on values of the skipped output latents and the non-skipped output latents for all K groups.
EEE11. The method of EEE10, wherein determining decoded skipped and non-skipped quantized latents comprises:
   if

$${σ}_{i}^{j} < {mean}_{} ( {σ}_{i}^{j} ) ,$$

then entropy encoding of ŷᵢ was skipped and

$${\hat{y}}_{i} = {μ}_{i}^{k} ,$$

else ŷᵢ was entropy encoded and its value is generated by an entropy decoder,
wherein

$${mean}_{} ( {σ}_{i}^{j} )$$

denotes the average of all

$${σ}_{i}^{j}$$

values for quantized latents in group j.
EEE12. A non-transitory computer-readable storage medium having stored thereon computer-executable instructions for executing with one or more processors a method in accordance with any one of EEE1 to EEE11.
EEE13. An apparatus comprising a processor and configured to perform a method in accordance with any one of EEE1 to EEE11.

1. In a neural network for video coding, a method for skipping entropy encoding of quantized latents, the method comprising:
inputting video content into a neural-network encoder to generate latents (yᵢ);
quantizing the latents to generate quantized latents (ŷᵢ);
estimating mean values (μᵢ) and standard deviations (σᵢ) of the latents; and
applying entropy encoding to the quantized latents, wherein for a quantized latent (ŷᵢ)
if
$${σ}_{i} < {mean}_{} ( {σ}_{i} ) ,$$
then ŷᵢ=μᵢ, and its entropy encoding is skipped,
else the quantized latent (ŷᵢ) is entropy encoded to generate an entropy encoded latent, wherein mean(σᵢ) denotes the average of all σᵢ values, for i=1, 2, . . . N, where N denotes the total number of generated latents.

2. In a neural network for video coding, a method for skipping entropy encoding of quantized latents, the method comprising:
inputting video content into a neural-network encoder to generate latents (yᵢ);
quantizing the latents to generate quantized latents (ŷᵢ);
estimating mean values (μᵢ) of the latents; and
applying entropy encoding to the quantized latents, wherein for a latent yᵢ,
if |μᵢ|<τ, then ŷᵢ=ε*sign(μᵢ) and its entropy encoding is skipped,
else the quantized latent (ŷᵢ) is entropy encoded to generate an entropy encoded latent, wherein τ denotes a threshold, and ε denotes a small positive value larger than zero and smaller than 0.001.

3. In an autoregressive neural network for video coding, a method for skipping entropy encoding of quantized latents, the method comprising:
inputting video content into a neural-network encoder to generate latents (y;);
quantizing the latents to generate quantized latents (\;);
estimating initial mean values
$$( {μ}_{i}^{0} )$$
and standard deviations
$$( {σ}_{i}^{0} )$$
of the latents;
applying the initial mean values
$$( {μ}_{i}^{0} )$$
and the initial standard deviations
$$( {σ}_{i}^{0} )$$
of the latents to an entropy-skip encoder to determine updated quantized latent values and whether a quantized latent value will be entropy encoded or entropy encoding for the quantized latent will be skipped;
based at least on the entropy-skipped and non-entropy skipped latents, estimating refined mean values
$$( {μ}_{i}^{r} )$$
and standard deviations
$$( {σ}_{i}^{r} )$$
of the latents; and
applying the refined mean values
$$( {μ}_{i}^{r} )$$
and standard deviations
$$( {σ}_{i}^{r} )$$
of the latents for the arithmetic encoding and arithmetic decoding of the latents to be entropy coded.

4. The method of claim 3, wherein determining updated quantized latent values and whether a quantized latent value will be entropy encoded or entropy encoding will be skipped, comprises:
if
$${σ}_{i}^{0} < {mean}_{} ( {σ}_{i}^{0} ) , then {\hat{y}}_{i} = {μ}_{i}^{0} ,$$
and its entropy encoding is skipped,
else ŷᵢ is entropy encoded to generate an entropy encoded latent,
wherein
$${mean}_{} ( {σ}_{i}^{0} )$$
denotes the average of all
$${σ}_{i}^{0}$$
values, for i=1, 2, . . . N, where N denotes the total number of generated latents.

5. The method of claim 3, wherein determining updated quantized latent values and whether a quantized latent value will be entropy encoded or entropy encoding will be skipped, comprises:
for a latent yᵢ,
if
$$\vert {μ}_{i}^{0} \vert < τ , then {\hat{y}}_{i} = ε * sign ( {μ}_{i}^{0} )$$
and its entropy encoding is skipped,
else the quantized latent (ŷᵢ) is entropy encoded to generate an entropy encoded latent, wherein τ denotes a threshold, and ε denotes a small positive value larger than zero and smaller than 0.001.

6. A method for decoding pictures using a neural network, the method comprising:
receiving a bitstream comprising coded latents and coded hyper-latents;
decoding the hyper-latents to generate hyperprior parameters and initial entropy parameters comprising initial mean values and initial scales;
applying the initial scales into an entropy-skip decoder to identify skipped output latents, wherein the skipped output latents comprise latents that were not entropy-coded by an encoder of the bitstream;
determining values of the skipped output latents based on the initial mean values;
applying the skipped output latents and the hyperprior parameters to a context model to generate refined entropy parameters comprising refined mean values and refined scales;
applying the refined entropy parameters to decode the coded latents and generate non-skipped output latents;
and generating an output decoded picture based at least on the values of the skipped output latents and the non-skipped output latents.

7. In a neural network for video coding, a method for skipping entropy encoding of quantized latents, the method comprising:
inputting video content into a neural-network encoder to generate latents (y);
quantizing the latents to generate quantized latents (ŷᵢ);
dividing the quantized latents into K non-overlapping groups of quantized latents;
estimating mean values
$$( {μ}_{i}^{0} )$$
and standard deviations
$$( {σ}_{i}^{0} )$$
of the quantized latents in group j=0 of the K groups based on hyper-latents;
applying the mean values
$$( {μ}_{i}^{0} )$$
and standard deviations
$$( {σ}_{i}^{0} )$$
of the latents to an entropy-skip encoder to determine output latent values for the group j=0;
for quantized latents in group j for groups j=1 to K−1 of the K groups:
estimating mean values
$$( {μ}_{i}^{j} )$$
and standard deviations
$$( {σ}_{i}^{j} )$$
of the quantized latents in the group j based on hyper-latents and the
$$( {μ}_{i}^{j - 1} , {σ}_{i}^{j - 1} )$$
values,
applying the mean values
$$( {μ}_{i}^{j} )$$
and standard deviations
$$( {σ}_{i}^{j} )$$
of the patents to the entropy-skip encoder to determine output coded latent values for the group j; and
generating a bitstream of encoded quantized latents based on the output coded latent values for the K groups.

8. The method of claim 7, wherein K=2 or 4.

9. The method of claim 7, wherein determining output latent values and whether a quantized latent value will be entropy encoded or entropy encoding will be skipped, comprises:
if
$${σ}_{i}^{j} < {mean}_{} ( {σ}_{i}^{j} ) , then {\hat{y}}_{i} = {μ}_{i}^{k} ,$$
and its entropy encoding is skipped,
else ŷᵢ is entropy encoded to generate an entropy encoded output latent,
wherein
$${mean}_{} ( {σ}_{i}^{j} )$$
denotes the average of all
$${σ}_{i}^{j}$$
values for quantized latents in group j.

10. A method for decoding pictures using a neural network, the method comprising:
receiving a bitstream comprising coded latents and coded hyper-latents, wherein the coded latents represent quantized latents divided into K non-overlapping groups;
for group j=0 of the coded latents:
decoding the hyper-latents to generate hyperprior parameters and initial entropy parameters comprising initial mean values
$$( {μ}_{i}^{0} )$$
and initial scales
$$( {σ}_{i}^{0} ) ;$$
applying the initial scales into an entropy-skip decoder to identify skipped output latents, wherein the skipped output latents comprise latents that were not entropy-coded by an encoder of the bitstream; and
determining values of the skipped output latents for group j=0 based on the initial mean values;
for group j, j=1 to K−1, of the coded latents:
estimating mean values
$$( {μ}_{i}^{j} )$$
and standard deviations
$$( {σ}_{i}^{j} )$$
of the quantized latents in the group j based on the hyper-latents and the
$$( {μ}_{i}^{j - 1} , {σ}_{i}^{j - 1} )$$
values; and
applying the estimated mean values
$$( {μ}_{i}^{j} )$$
and the standard deviations
$$( {σ}_{i}^{j} )$$
to decode the coded latents and generate skipped and non-skipped output latents.
and generating an output decoded picture based at least on values of the skipped output latents and the non-skipped output latents for all K groups.

11. The method of claim 10, wherein determining decoded skipped and non-skipped quantized latents comprises:
if
$${σ}_{i}^{j} < {mean}_{} ( {σ}_{i}^{j} ) ,$$
then entropy encoding of ŷᵢ was skipped and
$${\hat{y}}_{i} = {μ}_{i}^{k} ,$$
else ŷᵢ was entropy encoded and its value is generated by an entropy decoder,
wherein
$${mean}_{} ( {σ}_{i}^{j} )$$
denotes the average of all
$${σ}_{i}^{j}$$
values for quantized latents in group j.

12. A non-transitory computer-readable storage medium having stored thereon computer-executable instructions for executing with one or more processors a method in accordance with claim 1.

13. An apparatus comprising a processor and configured to perform a method in accordance with claim 1.
